(19) United States
(12) Patent Application Publication
(10) Pub. No.: US 2023/0032503 A1
(43) Pub. Date: Feb. 2, 2023

(54) SYSTEM FOR TRANSFERRING FLUID AND FLUID TRANSFER METHOD

(71) Applicant: Chiyoda Corporation, Yokohama-shi, Kanagawa (JP)

(72) Inventors: Fumihiko INABA, Yokohama-shi, Kanagawa (JP); Naoki WATANABE, Yokohama-shi, Kanagawa (JP)

(21) Appl. No.: 17/791,104

(22) PCT Filed: Mar. 13, 2020
(86) PCT No.: PCT/JP2020/011159

§ 371 Date: Jul. 6, 2022

(51) Int. Cl. B63B 27/24; F17C 9/00; F17C 13/00

(52) U.S. Cl. CPC B63B 27/24; F17C 9/00; F17C 13/00

(57) ABSTRACT

A system for transferring a fluid includes a transfer line connecting a storage tank and an LNG carrier, a loading arm provided on the transfer line, an emergency shutoff device configured to shut off the transfer line, a bypass line connecting the transfer line and the storage tank, and a bypass valve provided in the bypass line. The storage tank includes a fluid reception pipe configured to receive the fluid from the outside and a BOG pipe configured to discharge a boil-off gas of the fluid generated in the storage tank to the outside, and the bypass line is connected to at least one of the fluid reception pipe or the BOG pipe.

### TECHNICAL FIELD

The present invention relates to a system for storing a fluid that vaporizes at room temperature in a storage tank and transferring the fluid in the storage tank through piping to an LNG carrier, and a fluid transfer method.

### BACKGROUND ART

As described in Patent Document 1, in a system for transferring a fluid between onshore equipment and offshore floating equipment, use of a loading arm configured to adjust a connection position of piping is known. Further, such a loading arm is provided with an emergency shutoff device that shuts off fluid transfer and releases the connection between piping in an emergency in order to prevent damage to the piping and peripheral devices thereof caused by, for example, excessive oscillation of the floating equipment.

### CITATION LIST

### PATENT LITERATURE

Pat. Document 1: U.S. 2016/0258578 A

### SUMMARY OF INVENTION

### Technical Problem

In an onshore liquefied natural gas (LNG) production facility, the produced LNG is temporarily stored in a storage tank, and then, an LNG transfer system transfers the stored LNG from the storage tank to an LNG carrier at a predetermined timing. The LNG may be transferred in piping of a transfer line at high flow rates of about from 10,000 to 12,000 m³/h. The LNG transfer line is provided with a loading arm including an emergency shutoff device, and this is also known.

In such an LNG transfer system, in a case where the emergency shutoff device is activated due to the occurrence of an emergency, the flow of the LNG flowing at a high flow rate may be suddenly shut off by a shutoff valve provided in the LNG transfer line. At this time, the flow of the LNG having inertia is suddenly stopped, which causes the pressure of the LNG in the vicinity of the shutoff valve to abruptly rise and generates a large pressure surge. Further, at this time, the LNG flows back from the shutoff valve to the storage tank side, that is, an LNG pressure wave is reflected from the shutoff valve to the storage tank side. The flow of the LNG flowing back to the storage tank side is then shut off by a valve or the like provided on the storage tank side and directed once again toward the loading arm. As a result, the flow of the LNG is repeatedly reciprocated back and forth through the transfer line, which causes repeated abrupt pressure fluctuations in the LNG. Furthermore, gas is generated in the vicinity of the shutoff valve when the pressure of the LNG in the piping falls to or below the saturated vapor pressure of the LNG due to the backflow of the LNG. The generated gas collides with the flow of the LNG directed once again toward the loading arm on the storage tank side and is crushed, which causes large pressure fluctuations.

Generation of such a pressure surge can cause failure of the piping and peripheral equipment thereof. Further, such a pressure surge is not limited to the transfer of LNG, but can also similarly occur in the transfer of other fluids that vaporize at least at room temperature.

Therefore, to mitigate a pressure surge that occurs in an emergency, it is conceivable to provide a surge drum that temporarily stores a portion of the LNG flowing through the transfer line in an emergency. Nevertheless, such a surge drum requires a large capacity in order to receive the LNG at a high flow rate. As a result, a large-scale facility for the surge drum is required, escalating facility costs.

According to the present invention, a pressure surge generated in the transfer line is mitigated.

### Solution to Problem

According to a first aspect of the present invention, a system for transferring a fluid being a gas at room temperature and liquefied by cooling includes a storage tank configured to store the fluid, a transfer line connecting the storage tank and an LNG carrier, a loading arm provided on the transfer line, an emergency shutoff device provided in the loading arm and configured to shut off the transfer line, a bypass line connecting a branch portion provided upstream of the loading arm in the transfer line and the storage tank, and a bypass valve provided in the bypass line and in a closed state during transfer of the fluid. The storage tank includes a fluid reception pipe configured to receive the fluid from the outside and a BOG pipe configured to discharge a boil-off gas of the fluid generated in the storage tank to the outside, and the bypass line is connected to at least one of the fluid reception pipe or the BOG pipe.

As a result, in a system including a loading arm, even in a case in which the transfer line for transferring fluid is shut off due to activation of the emergency shutoff device of the loading arm, a portion of the fluid in the transfer line flows through the bypass line and into the storage tank, making it possible to mitigate a pressure surge generated in the transfer line.

According to a second aspect of the present invention, the system further includes a control device configured to control the bypass valve. The control device is configured to open the bypass valve from a closed state in a case where the emergency shutoff device is activated.

As a result, the bypass valve can be controlled to open from a closed state in a case where the emergency shutoff device is activated.

According to a third aspect of the present invention, the system further includes a plurality of the storage tanks, a plurality of the bypass lines connected to the plurality of storage tanks, and a plurality of the transfer lines. The plurality of transfer lines are connected to one another, and the control device is configured to open the bypass valve of any one of the plurality of bypass lines from a closed state in a case where the emergency shutoff device is activated.

As a result, even in a case in which one transfer line of the plurality of transfer lines is shut off by actuation of the emergency shutoff device, a portion of the fluid in the transfer line being shut off flows through the bypass line and into the corresponding storage tank, making it possible to mitigate a pressure surge generated in the plurality of transfer lines connected to the plurality of storage tanks.

According to a fourth aspect of the present invention, the system further includes a plurality of the transfer lines, and the control device is configured to open the bypass valve of the bypass line from a closed state in a case where the emergency shutoff device corresponding to any one of the plurality of transfer lines is activated.

As a result, even in a case in which any one of the plurality of transfer lines is shut off by actuation of the emergency shutoff device, a portion of the fluid in the transfer line being shut off flows through the bypass line and into the storage tank, making it possible to mitigate a pressure surge generated in the plurality of transfer lines connected to one storage tank.

According to a fifth aspect of the present invention, the branch portion provided in the transfer line is located onshore, and the loading arm is located offshore.

As a result, the entire bypass line can be provided onshore even in a case in which the loading arm is located offshore, making it possible to mitigate a pressure surge generated in the transfer line by an inexpensive configuration.

According to a sixth aspect of the present invention, at least one pressure inside the fluid reception pipe or inside the BOG pipe to which the bypass line is connected is the same as a pressure of a gas phase in the storage tank.

As a result, fluid flows stably into the storage tank via the bypass line without being affected by the pressure of the fluid received into the fluid reception pipe from the outside or of the boil-off gas discharged from the BOG pipe to the outside.

According to a seventh aspect of the present invention, a fluid transfer method is based on a system for transferring a fluid being a gas at room temperature and liquefied by cooling, the system including a storage tank onshore and configured to store the fluid, a transfer line connecting the storage tank and an LNG carrier to transfer the fluid to the LNG carrier, a loading arm provided on the transfer line, an emergency release device provided in the loading arm and configured to shut off the transfer line, a bypass line connecting a branch portion provided upstream of the loading arm in the transfer line and the storage tank, and a bypass valve provided in the bypass line and in a closed state during transfer of the fluid, the storage tank including a fluid reception pipe configured to receive the fluid from the outside and a gas discharge pipe configured to discharge a boil-off gas of the fluid generated in the storage tank to the outside, and the bypass line being connected to at least one of the fluid reception pipe or the gas discharge pipe. The fluid transfer method includes opening the bypass valve in a case where the emergency release device is activated.

As a result, in a system including a loading arm, even in a case in which the transfer line for transferring fluid is shut off due to activation of the emergency shutoff device of the loading arm, a portion of the fluid in the transfer line flows through the bypass line and into the storage tank, making it possible to mitigate a pressure surge generated in the transfer line.

According to an eighth aspect of the present invention, the system further includes a plurality of the storage tanks, a plurality of the bypass lines connected to the plurality of storage tanks, and a plurality of the transfer lines. The plurality of transfer lines are connected to one another, and the bypass valve of the bypass line is opened from a closed state in a case where the emergency shutoff device is activated.

As a result, even in a case in which one transfer line of the plurality of transfer lines is shut off by actuation of the emergency shutoff device, a portion of the fluid in the transfer line being shut off flows through the bypass line and into the corresponding storage tank, making it possible to mitigate a pressure surge generated in the plurality of transfer lines connected to the plurality of storage tanks.

According to a ninth aspect of the present invention, the system further includes a plurality of the transfer lines, and the bypass valve of the bypass line is opened from a closed state in a case where the emergency shutoff device corresponding to any one of the plurality of transfer lines is activated.

As a result, even in a case in which any one of the plurality of transfer lines is shut off by actuation of the emergency shutoff device, a portion of the fluid in the transfer line being shut off flows through the bypass line and into the storage tank, making it possible to mitigate a pressure surge generated in the plurality of transfer lines connected to one storage tank.

### ADVANTAGEOUS EFFECTS OF INVENTION

Thus, according to the present invention, a pressure surge generated in the transfer line is mitigated.

### BRIEF DESCRIPTION OF DRAWINGS

FIG. 1 is an overall configuration diagram illustrating an overview of an LNG transfer system according to a first embodiment.

FIG. 2 is a diagram illustrating a first modification example of the LNG transfer system according to the first embodiment.

FIG. 3 is a diagram illustrating a second modification example of the LNG transfer system according to the first embodiment

FIG. 4 is an overall configuration diagram illustrating an overview of the LNG transfer system according to a second embodiment

### DESCRIPTION OF EMBODIMENTS

Embodiments of the present invention are described below with reference to the drawings.

### First Embodiment

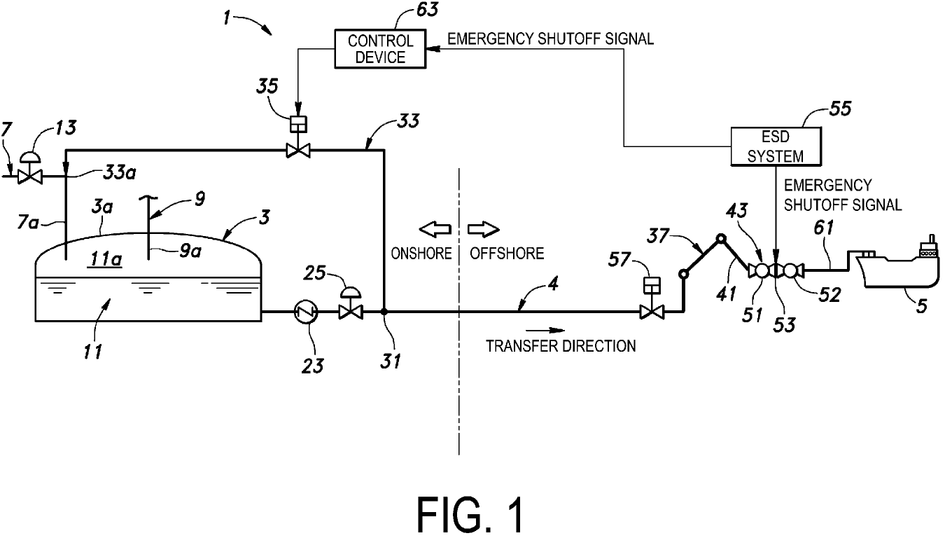

FIG. 1 is an overall configuration diagram illustrating an overview of an LNG transfer system 1 according to a first embodiment.

The LNG transfer system 1 transfers LNG stored in a storage tank 3 onshore to an LNG carrier 5 offshore via a transfer line 4.

The storage tank 3 is provided with a fluid reception pipe 7 and a boil-off gas (BOG) pipe 9. The fluid reception pipe 7 passes through an upper wall 3a of the storage tank 3 and supplies the LNG from the outside to inside the storage tank 3. The fluid reception pipe 7 includes a vertical portion 7a extending in a vertical direction. Similarly, the BOG pipe 9 passes through the upper wall 3a of the storage tank 3 and discharges boil-off gas of the LNG generated in the storage tank 3 to the outside. The BOG pipe 9 includes a vertical portion 9a extending in the vertical direction. Lower ends of these vertical portions 7a, 9a are located in a gas phase 11a of LNG 11 stored in the storage tank 3.

The LNG from the outside is supplied to the fluid reception pipe 7. Such LNG is generated by liquefying natural gas in an LNG liquefaction system (not illustrated). An expansion valve 13 is provided in the fluid reception pipe 7. The LNG from the LNG liquefaction system expands by the expansion valve 13, is thus adjusted in temperature to approximately -162° C., and flows into the storage tank 3.

The boil-off gas discharged from the BOG pipe 9 is re-liquefied using a compressor and a cooler (not illustrated).

The transfer line 4 connects the storage tank 3 and the LNG carrier 5 onshore to transfer the LNG. In the following description, the storage tank 3 side of the transfer line 4 that supplies LNG is regarded as upstream, and the LNG carrier 5 side of the transfer line 4 that receives LNG is regarded as downstream.

In the transfer line 4, a pump (not illustrated) that transfers the LNG is provided in the vicinity of the storage tank 3. Further, a check valve 23 and a flow regulating valve 25 are provided in this order downstream of the pump in the transfer line 4.

Further, the transfer line 4 onshore is provided with a bypass branch portion 31. A bypass line 33 connects the bypass branch portion 31 of the transfer line 4 and the fluid reception pipe 7 of the storage tank 3. A connecting portion 33a of the bypass line 33 connecting to the fluid reception pipe 7 is downstream of the expansion valve 13. The bypass line 33 includes a bypass valve 35 and, during normal transfer, the bypass valve 35 shuts off the inflow of the LNG from the transfer line 4 to the bypass line 33.

Further, the transfer line 4 offshore is provided with a loading arm 37 for fluid cargo handling. The loading arm 37 is provided with an emergency shutoff device 43 that shuts off the transfer line 4 downstream of an arm body 41 thereof. The emergency shutoff device 43 includes two emergency shutoff valves 51, 52 and an emergency release coupler 53 interposed therebetween.

Further, the loading arm 37 includes an emergency shutdown (ESD) system 55 that actuates the emergency shutoff device 43. The ESD system 55 operates in an emergency in which an angle abnormality of the arm body 41 occurs, and transmits an emergency shutoff signal to the emergency shutoff device 43. As a result, the emergency shutoff device 43 that receives the emergency shutoff signal is activated. Then, in the emergency shutoff device 43, the two emergency shutoff valves 51, 52 are closed, and the emergency release coupler 53 is subsequently opened. The opening of the emergency release coupler 53 is performed by, for example, control of hydraulic pressure.

Note that the emergency shutoff device 43 is not limited to the configuration illustrated herein. Further, the emergency shutoff device 43 provided in the loading arm 37 need not necessarily be integrally provided with the arm body 41. The emergency shutoff device 43 is provided in at least the transfer line 4, and need only shut off the flow of the LNG in the transfer line 4 in an emergency.

Further, a shutoff valve 57 that shuts off the transfer line 4 is provided on the transfer line 4 offshore, upstream of the loading arm 37. The shutoff valve 57 closes when the emergency shutoff valve 51 fails and shuts off the flow of the LNG in the transfer line 4.

The LNG carrier 5 includes a carrier-side tank (not illustrated). The carrier-side tank is filled with the LNG from the storage tank 3. Further, a carrier-side pipe 61 extending from the carrier-side tank is connected to one of the emergency shutoff valves 51, 52, namely, emergency shutoff valve 52 at an upstream end of the carrier-side pipe 61, and constitutes a portion of the transfer line 4. The LNG carrier 5 transfers the LNG received from the storage tank 3 to another location.

Note that, in this embodiment, an example is illustrated in which the storage tank 3 is provided onshore, but the storage tank 3 may be provided offshore. The storage tank 3 can be provided on an offshore floating storage unit (FSU), a floating LNG (FLNG), or the like. Further, in the LNG transfer system 1, all components including the transfer line 4 may be provided offshore. When the LNG is transferred from the FLNG to the LNG carrier 5, a loading hose is used instead of the loading arm.

Further, the LNG transfer system 1 is provided with a control device 63. The control device 63 receives an emergency shutoff signal from the ESD system 55, which signals the activation of the emergency shutoff device 43 in an emergency, and controls the opening of the bypass valve 35. Note that the emergency shutoff signal received by the control device 63 is not limited to that transmitted from the ESD system 55. As long as the emergency shutoff signal is a signal that signals the activation of the emergency shutoff device 43, the signal may be transmitted from another device. Alternatively, instead of reception of the emergency shutoff signal, an operator of the LNG transfer system 1 may perform an input operation in the control device 63 for controlling the bypass valve 35.

During the LNG transfer operation, the LNG 11 in the storage tank 3 is transferred toward the LNG carrier 5 offshore by the pump of the transfer line 4. At this time, the bypass valve 35 of the bypass line 33 is in the closed state, and thus the LNG does not flow through the bypass line 33.

When an emergency occurs during the LNG transfer operation, the ESD system 55 transmits an emergency shutoff signal to the emergency shutoff device 43 and simultaneously transmits an emergency shutoff signal to the control device 63. Then, in the emergency shutoff device 43 receiving the emergency shutoff signal, the emergency shutoff valves 51, 52 are closed and the emergency release coupler 53 is opened. Further, the control device 63 receiving the emergency shutoff signal controls the bypass valve 35 from the closed state to the open state.

In this case, the flow of the LNG in the transfer direction in the transfer line 4 is shut off by the emergency shutoff valve 51. On the other hand, a portion of the LNG 11 in the transfer line 4 flows from the bypass branch portion 31 to the bypass line 33. Furthermore, the LNG flowing into the bypass line 33 flows through the fluid reception pipe 7 and into the storage tank 3. With such a bypass line 33, a pressure surge generated by sudden shutoff of the flow of the LNG in the transfer line 4 is mitigated. Note that the backflow of the LNG from the emergency shutoff valve 51 to the storage tank 3 via the transfer line 4 is stopped by the check valve 23.

Further, in the connecting portion 33a of the bypass line 33, a pressure in the fluid reception pipe 7 is substantially the same as a pressure of the gas phase 11a of the LNG 11 stored in the storage tank 3. Thus, the LNG of the bypass line 33 flows stably into the storage tank 3 without being affected by the pressure of the LNG supplied from the outside to the fluid reception pipe 7.

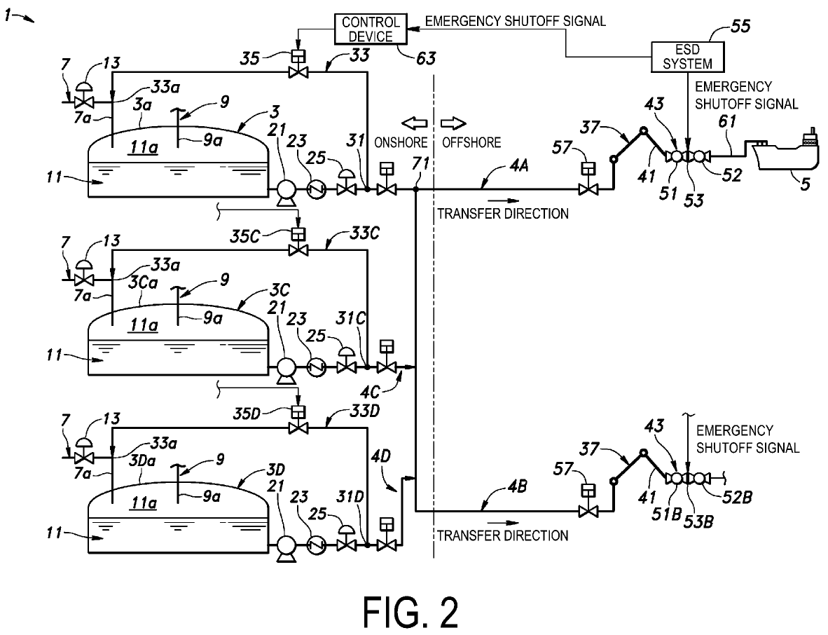

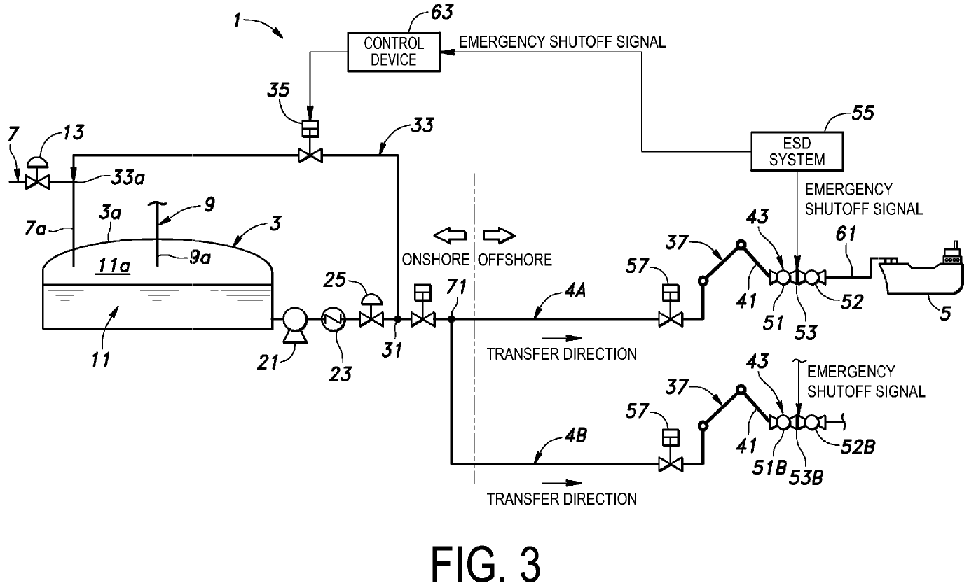

FIG. 2 is a diagram illustrating a first modification example of the LNG transfer system 1 according to the first embodiment. FIG. 3 is a diagram illustrating a second modification example of the LNG transfer system 1 according to the first embodiment. In FIGS. 2 and 3, components similar to those of the LNG transfer system 1 illustrated in FIG. 1 are denoted by the same reference signs. However, for convenience of description, auxiliary signs A to D are added to the numbers in the reference signs for some components. Further, the first and second modification examples of the LNG transfer system 1 are similar to those of the first embodiment described above except for the matters specifically mentioned below.

In the first modification example of the LNG transfer system 1, the storage tank 3, the bypass line 33 connected to the storage tank 3, and the transfer line 4 are each added. In the first modification example, in addition to a first transfer line 4A, which corresponds to the transfer line 4 in the first embodiment described above, a second transfer line 4B is provided. The second transfer line 4B has a configuration similar to that of the first transfer line 4A.

As illustrated in FIG. 2, a transfer line branch portion 71 (hereinafter referred to as “branch portion 71”) is provided in the first transfer line 4A onshore and downstream of the bypass branch portion 31. The second transfer line 4B branches from the first transfer line 4A at the branch portion 71.

Further, downstream ends of a third transfer line 4C and a fourth transfer line 4D are each connected to the second transfer line 4B branching from the branch portion 71. Upstream ends of the third transfer line 4C and the fourth transfer line 4D are respectively connected to storage tanks 3C, 3D independent of each other. Further, bypass branch portions 31C, 31D are respectively provided upstream of the third transfer line 4C and the fourth transfer line 4D, and each of the bypass branch portions 31 is connected to the corresponding storage tank 3 via a corresponding one of bypass lines 33C, 33D.

Note that, in addition to the first transfer line 4A and the second transfer line 4B, an additional transfer line constituting the downstream side may be added. Further, in addition to the third transfer line 4C and the fourth transfer line 4D, an additional transfer line constituting the upstream side as well as equipment for supplying LNG thereto may be added.

In the first modification example of the LNG transfer system 1, during an LNG transfer operation, the LNG is transferred from any one of the three storage tanks 3, 3C, 3D via the first transfer line 4A or the second transfer line 4B. At this time, the bypass valves 35, 35C, 35D of the bypass lines 33, 33C, 33D are in a closed state, and thus the LNG does not flow through the bypass lines 33, 33C, 33D.

For example, when an emergency occurs during the LNG transfer operation using the second transfer line 4B and the third transfer line 4C, emergency shutoff valves 51B, 52B in the second transfer line 4B are closed, and an emergency release coupler 53B is released. Further, the control device 63 receiving the emergency shutoff signal controls the bypass valves 35, 35C, 35D in all bypass lines 33, 33C, 33D such that the bypass valves 35, 35C, 35D is set from the closed state to the open state.

In this case, the flow of the LNG in the transfer direction in the second transfer line 4B is shut off by the emergency shutoff valve 51B of the second transfer line 4B. On the other hand, a portion of the LNG 11 in the second transfer line 4B flows through the bypass lines 33, 33C, 33D and into at least one of the storage tanks 3, 3C, 3D that had supplied the LNG. Accordingly, pressure surges generated in the plurality of transfer lines connected to the plurality of storage tanks can be mitigated.

In the second modification example of the LNG transfer system 1, as illustrated in FIG. 3, the third transfer line 4C and fourth transfer line 4D as well as the equipment supplying the LNG thereto in the first modification example are omitted. That is, the LNG transfer system 1 can include the plurality of transfer lines 4A, 4B connected to one storage tank 3. In this case as well, a portion of the liquefied fluid in the transfer line 4A or the transfer line 4B shut off flows through the bypass line 33 and into the storage tank. Accordingly, pressure surges generated in the plurality of transfer lines connected to one storage tank 3 can be mitigated.

### Second Embodiment

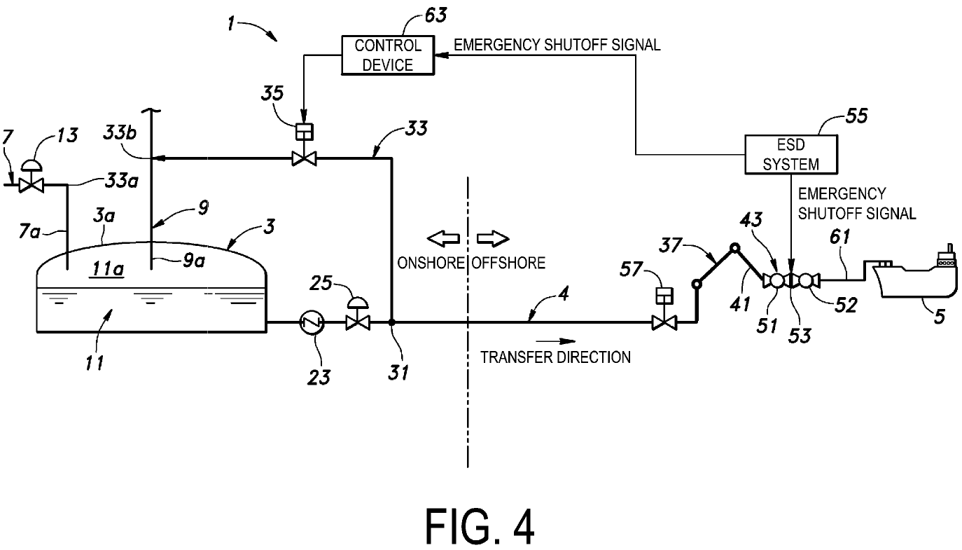

FIG. 4 is an overall configuration diagram illustrating an overview of the LNG transfer system 1 according to a second embodiment. In FIG. 4, components similar to those of the LNG transfer system 1 illustrated in FIG. 1 are denoted by the same reference signs. Further, the LNG transfer system 1 according to the second embodiment is similar to that of the first embodiment or the modification examples thereof described above except for the matters specifically mentioned below.

In the LNG transfer system 1 according to the second embodiment, the bypass line 33 is connected to the bypass branch portion 31 of the transfer line 4 and the BOG pipe 9 of the storage tank 3.

When an emergency occurs during an LNG transfer operation, the LNG flowing into the bypass line 33 flows through the BOG pipe 9 and into the storage tank 3. By such utilization of the bypass line 33, a pressure surge generated by sudden shutoff of the LNG flow in the transfer line 4 is mitigated.

Further, in the connecting portion 33b of the BOG pipe 9 connecting to the bypass line 33, the pressure in the pipe is substantially the same as the pressure of the gas phase 11a of the LNG 11 stored in the storage tank 3. As a result, the LNG of the bypass line 33 flows stably into the storage tank 3 without being affected by the pressure of the boil-off gas discharged from the BOG pipe 9 to the outside.

Note that, in the LNG transfer system 1 according to the second embodiment as well, a plurality of the storage tanks 3 and a plurality of the transfer lines 4 connected thereto can be provided similarly to the modification examples of the LNG transfer system 1 according to the first embodiment. Further, the bypass line 33 may branch in the middle, and thus be further connected to the fluid reception pipe 7 in the same manner as in the first embodiment. In this case, whether the LNG flowing through the bypass line 33 is to flow into the fluid reception pipe 7 or the BOG pipe 9 may be selected by an opening/closing operation of valves (not illustrated) respectively provided on the fluid reception pipe 7 side and the BOG pipe 9 side.

Although the present invention has been described using specific embodiments, these embodiments are merely illustrative, and the present invention is not limited by these embodiments. The components of the system for transferring a fluid and the fluid transfer method according to the present invention described above in the embodiments are not all necessary and can be appropriately selected by at least a person skilled in the art without departing from the scope of the present invention.

The system for transferring a fluid and the fluid transfer method according to the present invention are applicable to not only LNG, but any fluid that vaporizes at room temperature. For example, liquefied petroleum gas (LPG) may be used as the fluid that vaporizes at room temperature.

### REFERENCE SIGNS LIST

1 LNG transfer system
3 Storage tank
4 Transfer line
4A First transfer line
4B Second transfer line
4C Third transfer line
4D Fourth transfer line
5 LNG carrier
7 Fluid reception pipe
9 BOG pipe
11a Gas phase
13 Expansion valve
23 Check valve
25 Flow regulating valve
31 Bypass branch portion
33 Bypass line
35 Bypass valve
37 Loading arm
41 Arm body
43 Emergency shutoff device
51 Emergency shutoff valve
52 Emergency shutoff valve
53 Emergency release coupler
55 ESD system
57 Shutoff valve
61 Carrier-side pipe
63 Control device
71 Transfer line branch portion

1. A system for transferring a fluid being a gas at room temperature and liquefied by cooling, the system comprising:
a storage tank configured to store the fluid;
a transfer line connecting the storage tank and an LNG carrier;
a loading arm provided on the transfer line;
an emergency shutoff device provided in the loading arm and configured to shut off the transfer line;
a bypass line connecting a branch portion provided upstream of the loading arm in the transfer line and the storage tank; and
a bypass valve provided in the bypass line and in a closed state during transfer of the fluid, wherein
the storage tank includes a fluid reception pipe configured to receive the fluid from the outside and a BOG pipe configured to discharge a boil-off gas of the fluid generated in the storage tank to the outside, and
the bypass line is connected to at least one of the fluid reception pipe or the BOG pipe.

2. The transfer system according to claim 1, further comprising:
a control device configured to control the bypass valve, wherein
the control device is configured to open the bypass valve from a closed state in a case where the emergency shutoff device is activated.

3. The system according to claim 1, further comprising:
a plurality of the storage tanks;
a plurality of the bypass lines connected to the plurality of storage tanks; and
a plurality of the transfer lines, wherein
the plurality of transfer lines are connected to one another, and
the control device is configured to open the bypass valve of any one of the plurality of bypass lines from a closed state in a case where the emergency shutoff device is activated.

4. The system according to claim 1, further comprising:
a plurality of the transfer lines, wherein
the control device is configured to open the bypass valve of the bypass line from a closed state in a case where the emergency shutoff device corresponding to any one of the plurality of transfer lines is activated.

5. The system according to claim 1, wherein
the branch portion provided in the transfer line is located onshore, and
the loading arm is located offshore.

6. The system according to claim 1, wherein
at least one pressure inside the fluid reception pipe or inside the BOG pipe to which the bypass line is connected is the same as a pressure of a gas phase in the storage tank.

7. A fluid transfer method by a system for transferring a fluid being a gas at room temperature and liquefied by cooling, the system including:
a storage tank configured to store the fluid;
a transfer line connecting the storage tank and an LNG carrier to transfer the fluid to the LNG carrier;
a loading arm provided on the transfer line;
an emergency shutoff device provided in the loading arm and configured to shut off the transfer line;
a bypass line connecting a branch portion provided upstream of the loading arm in the transfer line and the storage tank; and
a bypass valve provided in the bypass line and in a closed state during transfer of the fluid,
the storage tank including a fluid reception pipe configured to receive the fluid from the outside and a BOG pipe configured to discharge a boil-off gas of the fluid generated in the storage tank to the outside, and
the bypass line being connected to at least one of the fluid reception pipe or the BOG pipe,
the fluid transfer method comprising opening the bypass valve in a case where the emergency shutoff device is activated.

8. The fluid transfer method according to claim 7, wherein
the system further includes a plurality of the storage tanks, a plurality of the bypass lines connected to the plurality of storage tanks, and a plurality of the transfer lines,
the plurality of transfer lines are connected to one another, and
the bypass valve of any one of the plurality of bypass lines is opened from a closed state in a case where the emergency shutoff device is activated.

9. The fluid transfer method according to claim 7, wherein
the system further includes a plurality of the transfer lines, and
the bypass valve of the bypass line is opened from a closed state in a case where the emergency shutoff device corresponding to any one of the plurality of transfer lines is activated.

10. The system according to claim 2, further comprising:
a plurality of the storage tanks;
a plurality of the bypass lines connected to the plurality of storage tanks; and
a plurality of the transfer lines, wherein
the plurality of transfer lines are connected to one another, and
the control device is configured to open the bypass valve of any one of the plurality of bypass lines from a closed state in a case where the emergency shutoff device is activated.

11. The system according to claim 2, further comprising:
a plurality of the transfer lines, wherein the control device is configured to open the bypass valve of the bypass line from a closed state in a case where the emergency shutoff device corresponding to any one of the plurality of transfer lines is activated.

12. The system according to claim 2, wherein
the branch portion provided in the transfer line is located onshore, and
the loading arm is located offshore.

13. The system according to claim 3, wherein
the branch portion provided in the transfer line is located onshore, and
the loading arm is located offshore.

14. The system according to claim 4, wherein
the branch portion provided in the transfer line is located onshore, and
the loading arm is located offshore.

15. The system according to claim 2, wherein
at least one pressure inside the fluid reception pipe or inside the BOG pipe to which the bypass line is connected is the same as a pressure of a gas phase in the storage tank.

16. The system according to claim 3, wherein
at least one pressure inside the fluid reception pipe or inside the BOG pipe to which the bypass line is connected is the same as a pressure of a gas phase in the storage tank.

17. The system according to claim 4, wherein
at least one pressure inside the fluid reception pipe or inside the BOG pipe to which the bypass line is connected is the same as a pressure of a gas phase in the storage tank.

18. The system according to claim 5, wherein
at least one pressure inside the fluid reception pipe or inside the BOG pipe to which the bypass line is connected is the same as a pressure of a gas phase in the storage tank.
